(19) United States
(12) Patent Application Publication
(10) Pub. No.: US 2004/0078179 A1
(43) Pub. Date: Apr. 22, 2004

(54) Logic verification system

(75) Inventors: Mototsugu Fuji, Ebina (JP); Osamu Tada, Hatano (JP); Kazunobu Morimoto, Yokohama (JP); Akira Yamagiwa, Higashimurayama (JP); Hisashi Nanao, Fujisawa (JP)

Correspondence Address: Stanley P. Fisher, Reed Smith LLP, Suite 1400, 3110 Fairview Park Drive, Falls Church, VA, 22042-4503, US

(73) Assignee: Renesas Technology Corp.

(21) Appl. No.: 10/681,206

(22) Filed: Oct. 9, 2003

(30) Foreign Application Priority Data
Oct. 17, 2002 (JP) 2002-303415

(51) Int. Cl. G06F 17/50

(52) U.S. Cl. 703/15

(57) ABSTRACT

There is provided a logic verification system having improved development time and design quality, in which all pins of an FPGA module are wired in direct between the FPGA module and a bridge circuit used in the verification processes of a logic simulator accelerator and a logic emulator, a cutting end of the verification object logic is assigned to an external interface connector of the FPGA module when the logic simulation is accelerated, and the correspondence between each pin of external interface connector of the FPGA module and logic signal is performed on the logic simulator on the general purpose processor.

### BACKGROUND OF THE INVENTION

The present invention relates to a logic verification system and more specifically to the technology which may be effectively applied, for example, to a logic simulator (emulator) to be used for development and design of a system LSI (Large Scale Integrated circuit device).

In these years, a logic emulation system utilizing FPGA (Field Programmable Gate Array) has been introduced as a logic verification means. When the logic emulation system is implemented, verification of I/F (Interface) with peripheral mounting components, verification of mounting substrate and detection of fault which cannot be detected easily with the logic simulation which have not been detected without generation of actual LSI are now possible and thereby design period and cost can be reduced. Moreover, since the processing time is extended with increase of the scale of LSI logic developed in recent years, a system to realize acceleration of logic simulation (improvement in the processing rate) is appearing as a product by mounting a part or the entire part of the verification object logic to the FPGA.

The Japanese Unexamined Patent Publication No. Hei 11(1999)-352190 (hereinafter referred to as the prior art 1) describes that the FPGA, a switching device and a connector are mounted as the FPGA modules, the logic interface assigned to each FPGA may be varies rather easily and is connected with the external peripheral components of logic such as peripheral components or the like via the mounted connector, and the relevant logic emulation system is formed in higher density and in smaller size than the commercially available logic emulation system, whereby this logic emulation system can be mounted on the same substrate with the peripheral components.

Meanwhile, the U.S. Pat. No. 6,009,256 (hereinafter referred to as the prior art 2) discloses a logic simulation device or a logic verification device which automatically separates into the portion to realize the logic and test bench with S/W and the portion to realize the same with H/W by inputting the logic and test bench described by the HDL and reading the logic format element (register, combining circuit, wire and clock generating circuit) from the HDL, generates a software model which can be executed with the CPU based on these portions and a hardware model programmed to the FPGA, and simultaneously operates these two models on the platform configured with the structural elements of CPU, system bus (PCI or the like) and FPGA.

[Patent Document 1]

Japanese Unexamined Patent Publication No. Hei

11(1999)-352190

[Patent Document 2]

U.S. Pat. No. 6,009,256

### SUMMARY OF THE INVENTION

Like the prior art 1, the FPGA is mounted or the FPGA can be mounted. In the case of the emulation system where respective FPGAs are connected with switching devices, a bridge circuit may be realized with the FPGA which can be mounted on the system of the prior art 1. However, since connection between the bridge circuit and each FPGA is surely made via the switching device, it is required to program this switching device. Moreover, on the occasion of shifting to the logic emulation from acceleration of the logic simulation, it is required to realize re-constitution by removing the device where the bridge circuit is mounted, mounting the peripheral actual components or interface connector in place of such device and then reprogramming the interface between the logic and these components with the switching device.

In the case of the emulation system where the FPGA is mounted or it is possible to mount the FPGA like the system of the prior art 1 and each FPGA is connected with a switching device, if two-way signal is provided for the interface between a bridge circuit and a verification object logic and a signal for switching the direction of the two-way signal (direction control signal of two-way signal) does not exist in the logic simulator side, it is required to add the direction control signal of two-way signal to the interface of the verification object logic and to transfer this signal to the logic simulator. The direction control signal of two-way signal is used for each two-way bus of logic and therefore many signals are required, resulting in a problem that the number of pins of the interface between bridge circuit and verification object logic increases.

Therefore, it is an object of the present invention to provide a logic verification system which has improved the time required for the development. Another object of the present invention is to provide a logic verification system which has improved the design quality. The above-described and the other objects and novel features of the present invention will become apparent from the description of the present specification and the accompanying drawings.

The typical inventions of the present invention can be described below briefly. When all pins of the FPGA module are connected in direct to accelerate logic simulation between the FPGA module and bridge circuit used in the verification process of a logic simulator accelerator and a logic emulator, a cutting end of the verification object logic is assigned to the external interface connector of the FPGA module and correspondence between each pin of the external interface connector of the FPGA module and a logic signal is realized on the logic simulator of a general purpose processor.

### BRIEF DESCRIPTION OF THE DRAWINGS

FIG. 1 is a flowchart for describing a design method and a verification method for an LSI to which the present invention is applied.

FIG. 2 is a structural diagram showing an embodiment of a logic emulation system of the present invention.

FIG. 3 is a block diagram showing an embodiment of an FPGA module used in the present invention.

FIG. 4 is a structural diagram showing an embodiment of a logic simulation accelerator of the present invention.

FIG. 5 is a block diagram for describing a verification object logic to be realized for the FPGA module used in the present invention.

FIG. 6 is a block diagram showing the embodiment where the verification object logics are assigned to a plurality of FPGAs on the FPGA module.

FIG. 7 is a reference diagram showing an example where the logics are assigned to a plurality of FPGAs of the logic emulator.

FIG. 8 is a reference diagram showing an example where logics are assigned to a plurality of FPGAs of the logic emulator mounting a switching device.

FIG. 9 is a reference diagram showing an example where logics are assigned to a plurality of FPGAs of the logic simulation accelerator.

FIG. 10 is a block diagram showing an example where the logics of FIG. 5 are assigned to the FPGA module mounting a plurality of FPGAs.

FIG. 11 is a flowchart for briefly describing an example of programming the logics to the FPGA module.

FIG. 12 is an external view for describing a connection example of the FPGA module and a board mounted on the FPGA module of the present invention.

FIG. 13 is an external view for describing a connection example of the FPGA module and an FPGA module configuration board of the present invention.

FIG. 14 is a diagram showing an example of common use of the FPGA module data with the logic simulation accelerator and logic emulator of the present invention

FIG. 15 is a diagram showing an example of common use of the FPGA module data with the logic simulation accelerator and logic emulator of the present invention.

FIG. 16 is a diagram for describing a method to set up the correspondence between the FPGA module and logic simulator of the present invention.

FIG. 17 is a diagram showing an embodiment to add a direction control signal of two-way signal to the verification object logic.

FIG. 18 is a block diagram showing an embodiment of the connection between a bridge circuit and the FPGA module of the present invention.

FIG. 19 is a timing chart for describing operations of the embodiment circuit of FIG. 18.

FIG. 20 is a block diagram showing another embodiment of the connection between the bridge circuit and FPGA module of the present invention.

FIG. 21 a level setting diagram for describing a method of determining the direction of signal of FIG. 20.

FIG. 22 is a timing chart for describing operations of the embodiment circuit of FIG. 20.

### DETAILED DESCRIPTION OF THE PREFERRED EMBODIMENTS

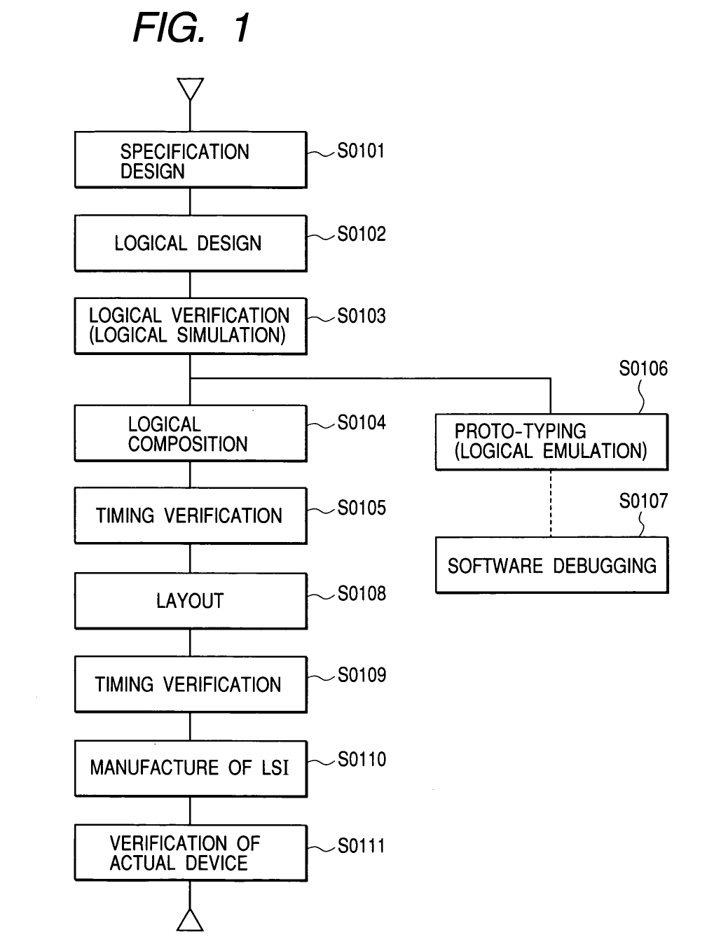

FIG. 1 is a flowchart for describing a design method and a verification method for an LSI to which the present invention is applied. In FIG. 1, the specification design is conducted to determine the specifications of circuit to be realized as indicated in the step S0101. Next, in the step S0102, a logic circuit is described in the register transfer level using the HDL (Hardware Description Language) based on the specifications determined in the step S0101 for the logic design. Thereafter, in the step S0103, the designed logic circuit is verified using a system called the logic simulator having the function to verify the operations by artificially operating the logic circuit of the step S0102 on the general purpose processor. This verification is generally called the logic simulation. Here, it is verified whether the logic function operates as specified or not.

When the logic function is verified, the logic synthesizing process of the step S0104 is executed to convert the circuit described with the register transfer level to the ASIC (LSI) gate circuit as the target. Since the circuit formed of the ASIC gate which is the actual target can be obtained as the output in the step S0104, it is verified whether the timing satisfies the specification or not after the execution as specified in the step S0105.

As specified in the step S0106, the logic emulation is performed using a programmable device such as the PFGA in parallel with verification by logic simulation, logic synthesizing and layout from the timing near the end of verification by the logic simulation. This verification is intended to operate the logic at the rate near to the actual operation through combination with actual peripheral components by programming the logic which is designed as the programmable device, detect specification error of actual components and extract, before manufacturing of LSI, failure on the case where execution is impossible in the logic simulation because a verification pattern is very longer.

When the logic designed for programmable device is programmed, the logic may be operated in the rate near the actual operation. Therefore, when the software which operates in combination with the designed logic is designed simultaneously such as the development of the built-in system, the software debug can be implemented before manufacturing of a sample of LSI as in the case of the step S0107 and thereby the design period can be reduced.

When there is no problem in the timing of the step S0105, the process goes to the step S0108. In this step, cells are allocated in a chip using the logic, as the input, which is converted to the ASIC gate circuit as the target in the step S0104 and the pins are wired conforming to the logic connections among the cells as the layout process. Thereafter, the final verification is performed to check whether the timing is satisfied or not as specified in the step S0109.

Upon completion of the verification in the steps S0106 and S0109, the LSI is actually manufactured in the step S0110. Thereafter, actual device is verified for the final verification in the step S0111. However, the logic emulation of the step S0106 is implemented, the common verification data and environment can be used. Moreover, since a failure which cannot naturally be detected in this timing is detected in the earlier stage, the actual device verification period can be curtailed remarkably.

The present invention relates to acceleration of logic simulation using a programmable device in the step S0103 and improvement of logic emulation using a programmable device in the step S0106 among the flows of FIG. 1.

The logic simulation realizes logic operations together with peripheral actual components mounted on the same board and an input/output device connected via the connectors by mounting a plurality of programmable devices corresponding to increase in the scale of the developed logic and then assigning the verification object logic to the programmable device. It is known that a mother board used in the logic emulation is manufactured conforming to the LSI designed by the LSI developers, or mounts a plurality of commercially available FPGAs and uses the logic emulation system which connects in direct such FPGAs or with a switching device.

However, when the mother board is manufactured conforming to the LSI to be designed, a problem that such mother board cannot be used for development of the other LSIs rises here. Moreover, here rises a problem that the interface of logic assigned to each FPGA, namely wiring among FPGAs cannot be changed easily. Meanwhile, in the case of the latter commercially available logic emulation system, a switching device may be used rather easily for change of logic interface assigned to each FPGA. Moreover, the LSI to be programmed for the logic emulation system may be changed or exchanged freely by preparing for general purpose connectors for the logic emulation and providing external peripheral components via the connectors.

However, an ordinary logic emulation system is large in size and cannot be mounted on the same substrate together with the peripheral components or the like. As a means for solving these problems, it is known to introduce a method to use the FPGA module disclosed in the prior art 1. Such FPGA module mounts FPGA, switching device and connector to rather easily change the logic interface assigned to each FPGA and also connects the external peripheral components of logic such as peripheral components via the connectors mounted. The logic emulation system may also be mounted on the same substrate together with the peripheral components or the like by lowering packing density and reducing size thereof than that of the commercially available logic emulation system.

As a system to realize acceleration of logic simulation using programmable device, there is provided the system in which a plurality of FPGAs are mounted and a general purpose interface for general purpose processor is provided to execute logic simulation. The processes that the signal is transmitted to a plurality of FPGAs through the general purpose interface from the logic simulator operating on the general purpose processor and moreover the signal is also returned to the logic simulator from a plurality of FPGAs through the general purpose interface have been realized by mounting the divided verification object logics to a plurality of FPGAs and then connecting these FPGAs to the general purpose interfaces to be connected to the general purpose processor. Accordingly, the logic operations which is naturally required to artificially operate on the general purpose processor can be executed on a plurality of FPGAs and thereby the processing time can be reduced.

Such logic simulation accelerator comprises a bridge circuit which is connected to the general purpose interface connected to the general purpose processor to mediate communication between the FPGA mounted and the general purpose processor using the function to make communication with the general purpose processor depending on the bus specification of the general purpose interface. This bridge circuit is connected with a plurality of FPGAs via a local bus and signals are sequentially exchanged depending on the predetermined bus specification. In the case of such connection, each FPGA and the bridge circuit may be wired depending on only the local bus specification independent of the mounted logics. However, it is required here to add the interface logic with the local bus which does not exist in the object logic to be mounted to the device to a cutting end of the divided logic mounted to each FPGA.

As the system to overcoming this problem, there is provided the system which can mount a plurality of FPGAs, realize the interface between the logic emulation device which can change with the programming the interface between the logics mounted to the FPGA and the device which is operated with the general purpose processor, enable the cooperative operations of the logic simulation and logic emulation through combination with the device which can exchange the signal with the logic simulator, and accelerate the logic simulation through actual operation of the verification object logics in the logic emulation side.

In the case of such system, connection between the bridge circuit which has the function to make communication with the general purpose processor depending on the bus specification of general purpose interface and mediates the communication between the mounted FPGA and the general purpose processor may be changed in flexible with the switching device. Moreover, connections among the FPGAs can also be changed. Accordingly, it is not required to connect the bridge circuit and each FPGA with the local bus which is different from the verification object logic described in the prior art 2, and it may be considered as the analyzing aspects of the logics realized with the FPGA.

However, since connection between the bridge circuit and each FPGA is always made via the switching device, it is required to execute the process to program this switching device. Moreover, in the case where acceleration of logic simulation is shifted to logic emulation, it is required, in some cases, to reform the interface between the logics and components through the programming of the switching device by removing the device mounting the bridge circuit and then mounting, in place of such device, the peripheral components or the interface.

In the case of this system, when a two-way signal exists in the interface between the bridge circuit and verification object logics and a signal to change over the direction of the two-way signal (direction control signal of two-way signal) does not exist in the logic simulator side, the direction control signal of this two-way signal is added to the interface of the verification object logics and this signal must be transferred to the logic simulator. Since this direction control signal of this two-way signal exists for each two-way bus of logics, a large number of signals are used, resulting in a problem that the number of pins of the interface between the bridge circuit and verification object logics increases.

In the case of the prior art 2, since the interface of local bus is added to the logics assigned to each FPGA when the logic simulation is accelerated, when the acceleration of logic simulation is shifted to the logic emulation, it is required to manufacture the logic emulation mother board mounting the FPGA in accordance with the logics and connections among the FPGAs and between the peripheral actual components and external interface of logics must be changed to the cutting end of actual logics from the local bus.

In the present invention, it is enabled to use program data of the same FPGA group mounting the verification object logics in a couple of verification processes of the logic simulation and logic emulation. Namely, the summary of the present invention is described below. The same FPGA module is used in the logic simulation accelerator consisting of a device operating on the general purpose processor and a device including a programmable logic device (FPGA or the like) and in the logic simulator including the programmable logic device (FPGA or the like).

When all pins of the FPGA module are connected in direct and the logic simulation is accelerated between the FPGA module and bridge circuit described above, the cutting end of the verification object logics is assigned to the external interface connector of the FPGA module. Moreover, correspondence between each pin of the external interface connector of the FPGA module and logic signal is established on the logic simulator of the general purpose processor.

The logic to be mounted to the FPGA module is provided with a means for automatically detecting signal direction of the two-way signal between the FPGA module providing a means to transmit the direction control signal of two-way signal to the bridge circuit using the interface of the two-way signal controlled by such direction control signal and the device which is mounting the bridge circuit. Accordingly, the program data of the same FPGA group mounting the verification object logic can be used in a couple of verification processes of acceleration of the logic simulation and logic emulation.

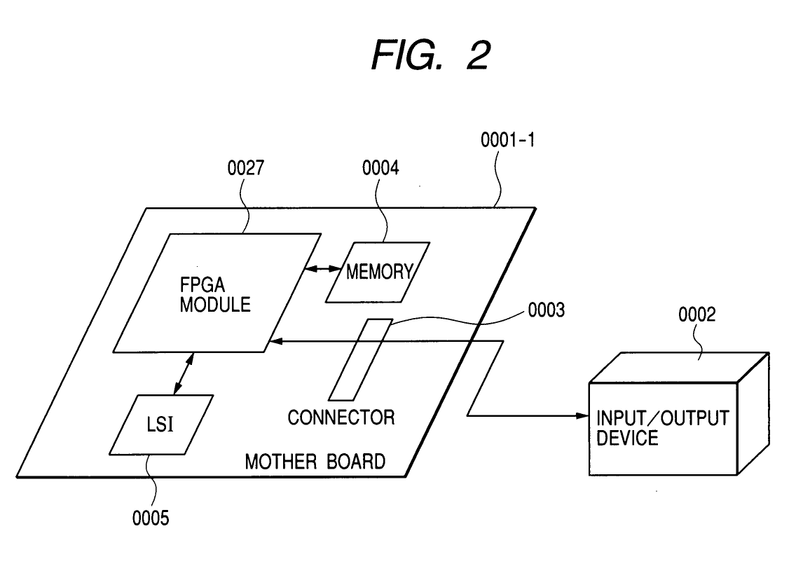

FIG. 2 is a structural diagram of an embodiment of a logic emulation system of the present invention. This embodiment is intended to the system to execute the logic emulation to be executed in the step S0106 of FIG. 1 using the FPGA module. In this figure, 0001-1 is a logic mother board mounting the FPGA module 0027 for programming the verification object logic, commercially available components, and existing LSI or the like. 0002 is a signal input/output device for inputting and outputting the signal to the mother board 0001-1, which is composed, for example, of speaker, display and microphone or the like.

0003 is a connector mounted to the mother board 0001-1 for connection with the input/output device 0002. 0027 is a FPGA module for programming the verification object logic. 0004, 0005 are examples of the peripheral components of the verification object logic, where 0005 is the existing LSI and 0004 is a memory. In this embodiment, the module 0027 gathers the FPGAs to form only one module and may also be removed at a time.

In the logic emulation system of this embodiment, as described above, a plurality of programmable devices are mounted corresponding to increase in the scale of developed logic, the verification object logic is divided and assigned to the programmable device, and the logical operations are realized in combination with the input/output device connected via the peripheral actual components and connectors mounted on the same board. The mother board used in the logic emulation of this embodiment mounts a plurality of commercially available FPGAs and uses the logic emulation systems which are connected in direct or connected via the switching device.

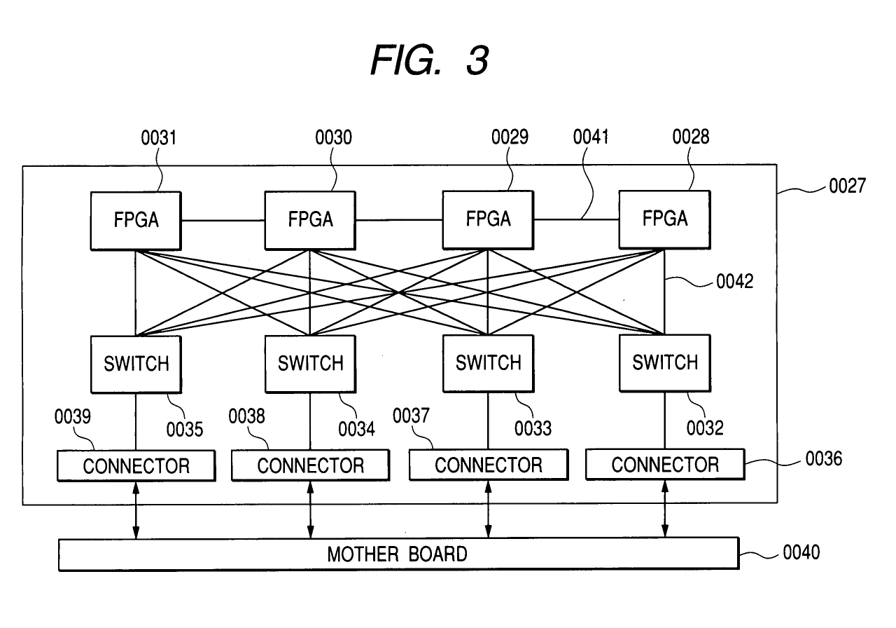

FIG. 3 is a block diagram of an embodiment of the FPGA module used in the present invention. The FPGA module of this embodiment mounts a large scale logic provided with a plurality of FPGAs, switching devices and connectors. 0027 is a FPGA module. 0028 to 0031 are FPGAs for dividing and programming the logic executed by the FPGA module. 0032 to 0035 are switching devices for connecting the logics mapped to each FPGA. 0036 to 0039 are connectors for inputting and outputting an external interface signal of logics mapped to each FPGA 0028 to 0031 to and from the FPGA module 0027. 0040 is a mother board to mount the FPGA module 0027 and is expressed as 0001-1 in FIG. 1. The signal can be inputted and outputted to the FPGA module 0027 from the mother board 0040 through the connectors for connection with the connectors 0036 to 0039. 0041 is a wire for connecting in direct two or more FPGAs of the FPGA module. 0042 is a wire for connecting the switch device and FPGA on the FPGA module.

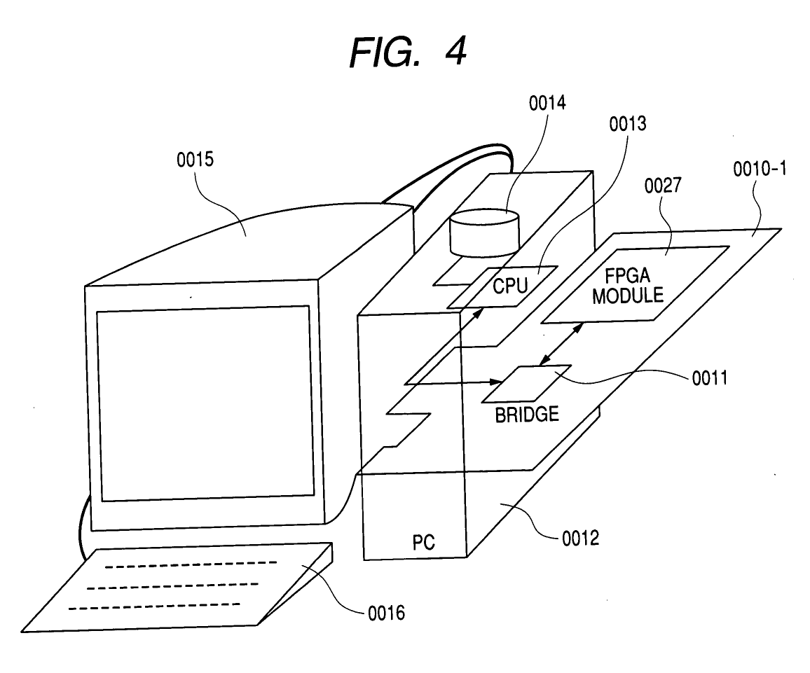

FIG. 4 is a structural diagram of an embodiment of the logic simulation accelerator of the present invention. The logic simulation accelerator of this embodiment accelerates the logic simulation implemented in the step S0103 of FIG. 1 and is realized by using the FPGA module of FIG. 3.

0010-1 is the board, for acceleration of logic simulation, provided with the mounted FPGA module 0027 for indicating the verification object logic with the hardware, a general purpose interface for transmitting and receiving signal to and from a personal computer/work station (P/W) and a device realizing a bridge circuit 0011 for exchange of data between the general purpose interface and FPGA. 0027 is the FPGA module illustrated in FIG. 3, while 0011 is the device for realizing the bridge circuit for sending and receiving data between the general purpose interface and FPGA and 0012 is an object device to mount the board 0010-1 via the general purpose interface which is composed, for example, of a personal computer PC.

The personal computer PC described above is provided with various devices. 0013 is a general purpose processor (CPU). 0014 is a disk memory for storing logic simulation program, input data to the logic simulation and output result from the logic simulation. 0015 is a display device such as a display to display the result of logic simulation. 0016 is an input device such as a keyboard as a user interface to execute the logic simulation.

The logic simulation accelerator of this embodiment executes the logic simulation program on the disk memory 0014 on the general purpose processor 0013. The bridge circuit 0011 transmits and receives the simulation object logic indicated by hardware on the FPGA and the signal via the general purpose interface to realize the simulation of verification object logic. When the FPGA module 0010-1 is not provided, artificial operation of the verification object logic which must be executed with the general purpose processor 0013 is actually operated as the logic indicated by the hardware on the FPGA. Thereby, the processing rate can be accelerated by reducing the number of processes to be executed with the general purpose processor 0013. The logic simulation accelerator in this embodiment gathers the FPGAs into one module and can be removed at a time.

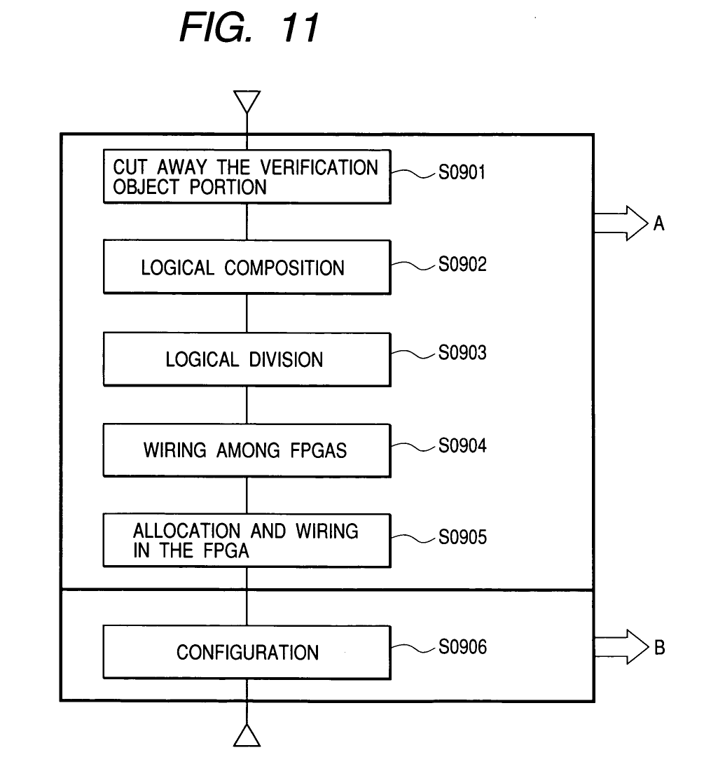

FIG. 11 illustrates a flowchart for briefly describing an example of the method for gathering the FPGAs into a module and programming a logic. In the step S0901, the process to extract the verification object logic to be realized to the FPGA module from the LSI in the design process is executed. Finally, the verification object logic becomes identical to the LSI as a whole under the design process, but acceleration of logic simulation and logic emulation can be executed by realizing the FPGA module from the function already designed.

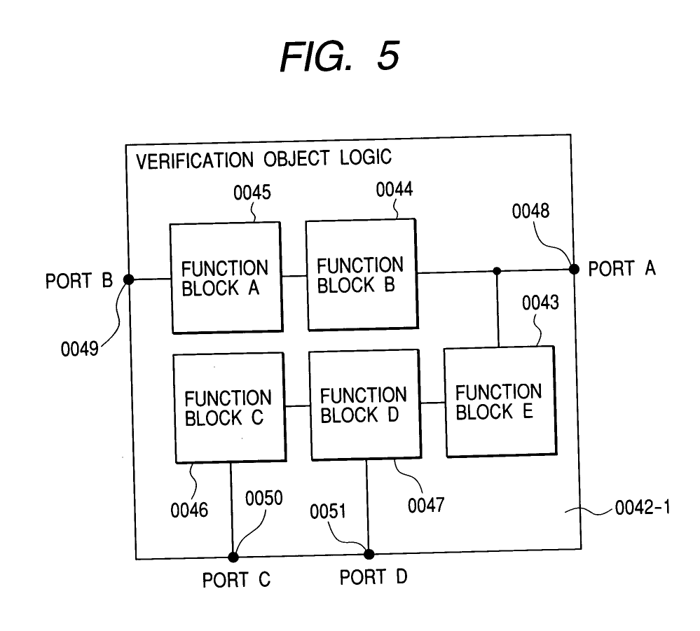

FIG. 5 is a block diagram for describing the verification object logic extracted. The verification object logic has an interface (cutting end) to exchange the signals between the verification object logic and external side. This cutting end is hereinafter called as a port. Moreover, the verification object logic has one or more functions. In the design of LSI in the register transfer level, these functions are often designed as a block. This block is hereinafter called a function block. The verification object logic is formed, as illustrated in the same figure, of the port, function block and net to exchange the signals among the function blocks.

In FIG. 11, the logic extracted in the step S0901 is converted, in the step S0902, to a circuit described with the gate of programmable device as the target. In this embodiment, the programmable device is expressed as FPGA. Next, the verification object logic is assigned to a plurality of FPGAs on the FPGA module in the step S0903.

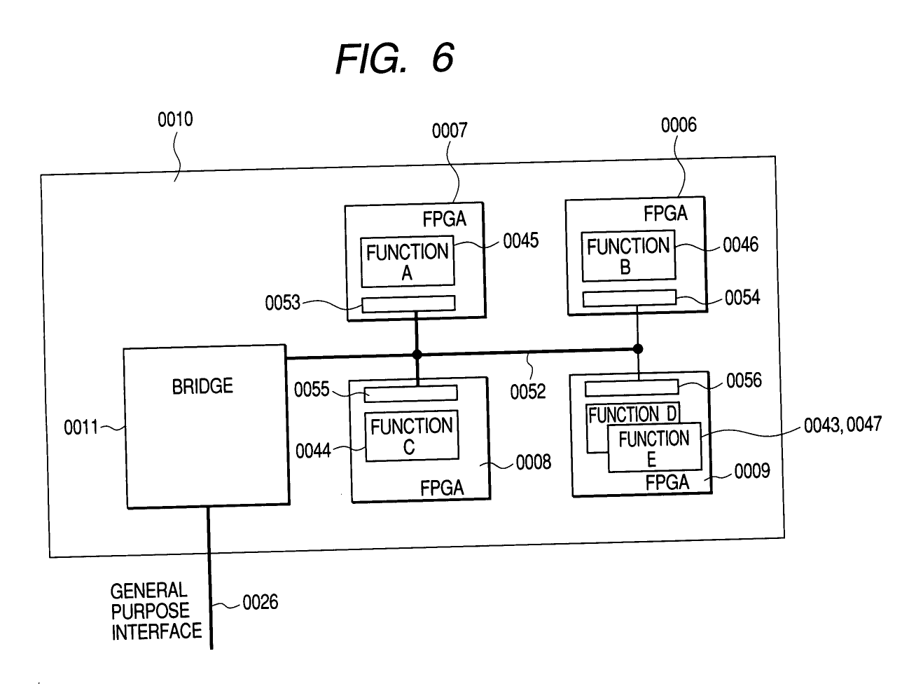

FIG. 6 illustrates a block diagram of the example where the verification object logic is assigned to a plurality of FPGAs on the FPGA module. 0010 is the board provided, for acceleration of the logic simulation, with mounted FPGAs to express the verification object logic with the hardware, general purpose interface to transmit and receive the signal to and from the PC and device realizing the bridge circuit to exchange data between the general purpose interface and FPGA.

0006 to 0009 are FPGAs for dividing the logic of FIG. 5 and then assigning the divided logics. 0011 is a device realizing the bridge circuit to exchange data between general purpose interface and FPGA. 0026 is the general purpose interface connected to the general purpose processor. 0052 is a local device for connecting the device 0011 realizing the bridge circuit and the FPGAs 0006 to 0009 on the board 0010. 0043 to 0047 are logic function blocks of FIG. 5 assigned to the FPGA. 0053 to 0056 are local interface circuits for transmitting and receiving data with the bridge circuit 0011 by converting the interfaces of the function blocks 0043 to 0047 to the interface of the local bus 0052.

A block diagram showing an example where the verification object logic is assigned to a plurality of FPGAs on the FPGA module is also provided. As illustrated in this block diagram, assignment to a plurality of FPGAs in unit of function block is also described in the prior art 1, but it is also possible, in this embodiment, to execute the assignment to a plurality of FPGAs bridging over the function blocks.

In FIG. 11, the port of verification object logic is assigned, in the step S0904, to the pins of the connector of the FPGA module and the logic connection among the logics assigned to a plurality of FPGAs on the FPGA module and the logic connection between the logic and port are performed, on the FPGA module of FIG. 3, using the wires 0041 and 0042 connecting the switch device and FPFA. In this case, connections in the switching device mounted on the FPGA module are also determined.

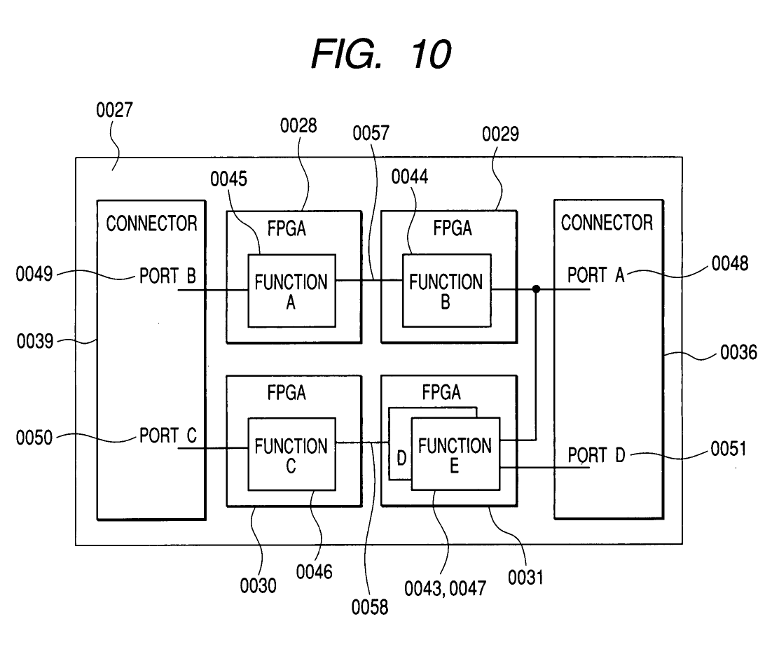

FIG. 10 is a block diagram indicating an example where the logic of FIG. 5 is assigned to the FPGA module mounting a plurality of FPGAs. 0027 is an FPGA module. 0029 to 0032 are FPGAs in which logic of FIG. 5 is divided and then assigned. 0036 and 0039 are connectors mounted on the FPGA module 0027 which are used to connect the external inerface of the logic assigned to the FPGA to the external side of the FPGA module.

0043 to 0047 are logic function blocks of FIG. 5 assigned to the FPGAs on the FPGA module 0027. 0048 to 0051 are external interface of logic of FIG. 5 connected to the connectors 0036, 0039. 0057 and 0059 are nets connecting among the function blocks of FIG. 5. In this embodiment, the port A and port D are assigned to the pins of the connector 0048, while the port B and port C, to the pins of the connector 0049. Moreover, connections 0057, 0058 among the logics are assigned to the wires 0041 and 0042.

In FIG. 11, wire assignment result for connections among logics determined in the step S0904 is inputted, in the step S0905, as restriction of pin allocation of FPGA to perform allocation and wiring processes in the FPGA for every division result logic assigned to each FPGA in the step S0903. When the process of the step S0905 is completed, the process for programming (configuration), for the FPGA, of the connection in the switching device determined in the step S0904 and the allocation and wiring result in the FPGA as the processing result of the step S0905 is executed as indicated in the step S0906. This process realizes operation of the programmed logic in the FPGA module.

Various methods for programming (configuration) of logic for the FPGA and switching device are presented from the FPGA makers and switching device makers. However, in general, the method is used in which the configuration data is stored in the memory and the configuration data is programmed to the FPGA and switching device in direct or via the LSI for controlling the configuration.

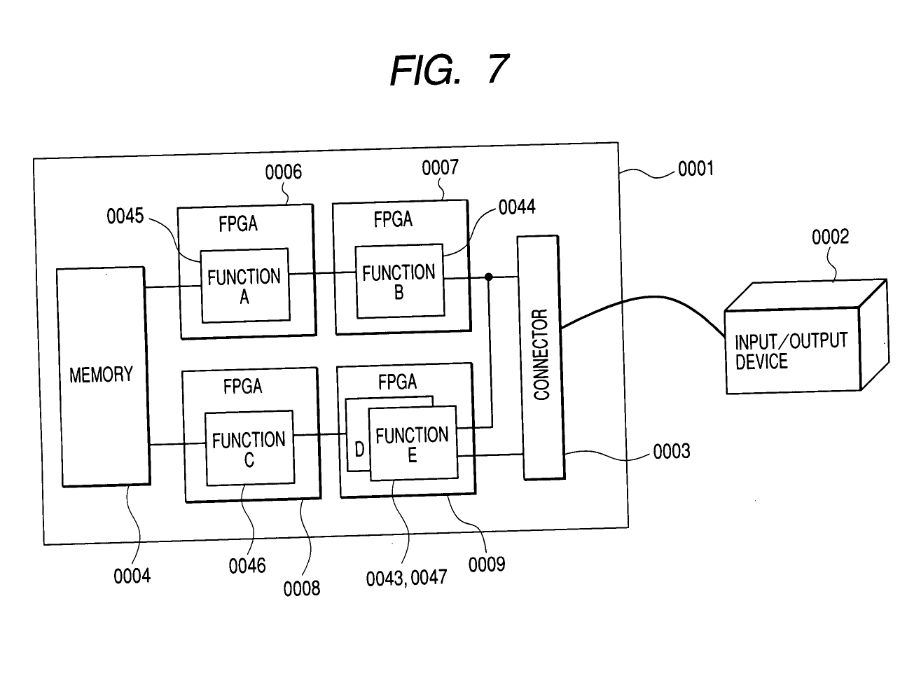

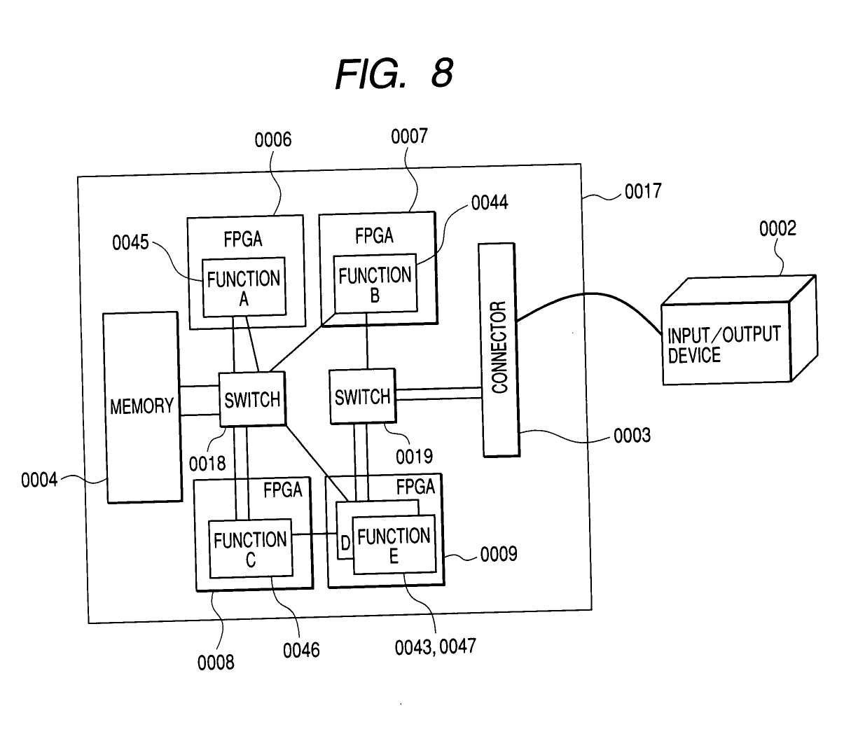

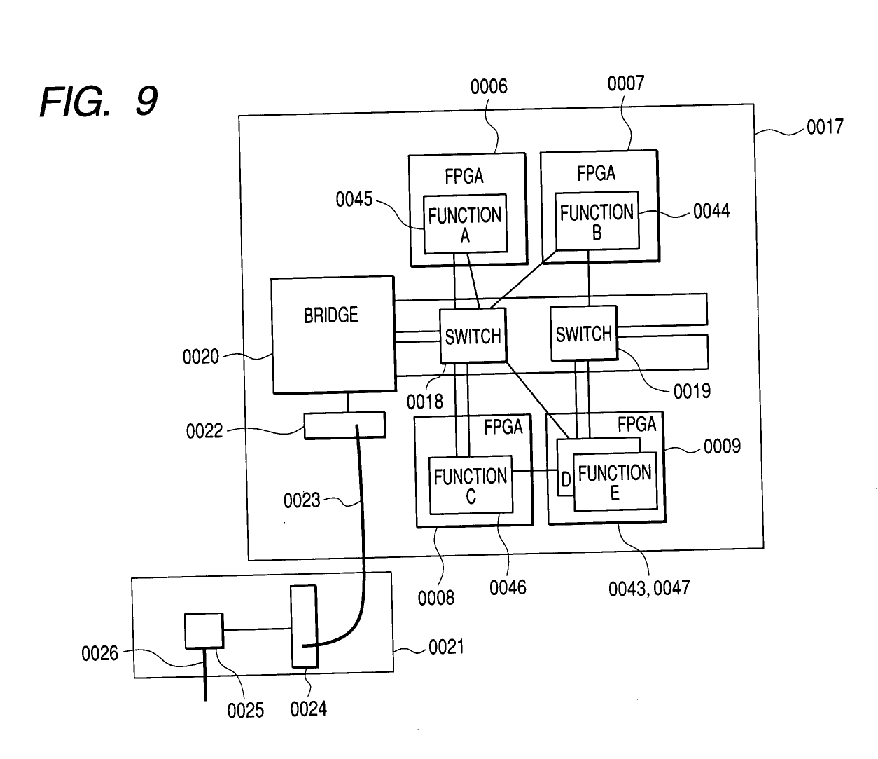

As the reference, FIG. 7 illustrates an example where logic is assigned to a plurality of FPGAs of the logic emulator, while FIG. 8 illustrates an example where logic is assigned to a plurality of FPGAs of the logic emulator mounting the switching device and FIG. 9 illustrates an example where logic is assigned to a plurality of FPGAs of the logic simulation accelerator connected in FIG. 8.

In FIG. 7, there is illustrated an example where the logic of FIG. 7 is assigned to the logic emulator mounting a plurality of FPGAs. 0001 is the logic emulation mother board mounting the FPGAs for programming the verification object logics, commercially available components, and the existing LSI or the like. 0002 is the signal input/output device, for example, speaker, display, and microphone for inputting and outputting the signals to the logic emulation mother board. 0003 is the connector for interface with the signal input/output device 0002. 0004 is the peripheral components of the verification object logic such as the memory. 0006 to 0009 are FPGAs to which the logic of FIG. 5 is divided and assigned. 0043 to 0047 are the logic function blocks A to E of FIG. 5 assigned to the FPGAs on the logic emulation mother board 0001.

In FIG. 8, there is illustrated an example where a plurality of FPGAs are mounted and the logic of FIG. 7 is assigned to the logic emulator which can change with programming the interface between the logics programmed for each FPGA. 0017 is the logic emulator which can mount the FPGAs for programming verification object logic, commercially available components and existing LSIs and can also change with the programming the interfaces of mounted components. 0006 to 0009 are the FPGAs for dividing and assigning the logic of FIG. 5. 0043 to 0047 are the logic function blocks A to E of FIG. 8 assigned to the FPGA on the logic emulation mother board. 0002 is the signal input/output device to input and output the signals to the emulation mother board such as speaker, display and microphone. 0003 is the connector for interface with the signal input/output device 0002. 0004 is the peripheral component of the verification object logic such as the memory. 0018, 0019 are the switching devices to connect with the programming the interfaces among the components mounted to the logic emulation mother board 0001.

In FIG. 9, there is illustrated an example where the logic of FIG. 5 is assigned to the system obtained by combining the device, including interface with the device operated with the general purpose processor to transmit and receive the signal to and from the logic simulator, to the logic emulator where a plurality of FPGAs are mounted and the interface between the logics programmed for each FPGA can be changed with programming. 0017 is the logic emulator which can mount the FPGA for programming the verification object logic, commercially available components, and existing LSIs and also can change the interface among mounted components with the programming. 0006 to 0009 are the FPGAs to divide and assign the logic of FIG. 5. 0043 to 0047 are the logic function blocks of FIG. 7 assigned to the FPGAs on the logic emulator 0001.

0018, 0019 are the switching devices for connecting with programming the interface among the components mounted to the logic emulator 0001. 0020 is the device mounting the bridge circuit which is connected with the interface of the logic circuits mounted to the logic emulator 0001 to transmit and receive the signal between the general purpose processor and the logic circuit mounted to the logic emulator 001 via the general purpose processor and the board 0021 including the general purpose interface through the connectors and cables. 0021 is the board mounted to the device which has the general purpose interface with the general purpose processor and is operated with the general purpose processor to transmit and receive the data between the connector mounted to the logic emulator 0001 and the general purpose processor via the connector and cable. 0022 is the connector to connect the cable connecting between the bridge circuit 0020 and board 0021 to the logic emulator 0001.

0023 is the cable for connecting the bridge circuit 0020 and the board 0021. 0024 is the connector to connect the cable 0023 in the side of board 0021. 0025 is the device realizing the bridge circuit 0020 connected to the general purpose interface connected to the general purpose processor with the cable 0023 and connectors 0022, 0024 and the bridge circuit to exchange the signal with the general purpose interface. 0026 is the general purpose interface connected to the general purpose processor.

FIG. 10 is a block diagram of the embodiment where the logic of FIG. 5 is assigned to the FPGA module mounting a plurality of FPGAs of the present invention. In this figure, 0027 is the FPGA module and 0029 to 0032 are the FPGAs to which the logic of FIG. 5 is divided and assigned. 0036, 0039 are the connectors mounted on the FPGA module 0027 to connect the external interface of logic assigned to the FPGAs to the external side of the FPGA module. 0043 to 0047 are the logic function blocks A to E of FIG. 5 assigned to the FPGAs on the FPGA module 0027. 0048 to 0051 are the external interface of the logic of FIG. 5 connected to the connectors 0036, 0039. 0057, 0048 are the nets connecting among the function blocks.

The process A consisting of the steps S0901 to S0905 of FIG. 11 is implemented only in the step S0103 of FIG. 1 and the process generated in the step S0103 is implemented in the step S0106. The process B of the step S0906 is implemented in the steps S0103 and S0106.

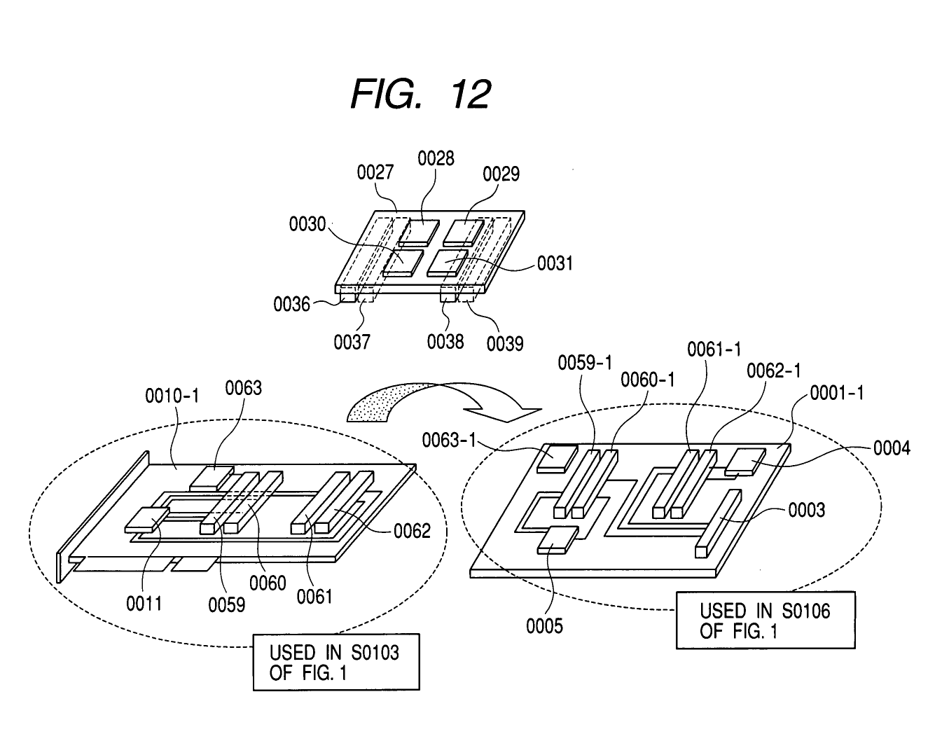

FIG. 12 is the external views for describing connection examples of the FPGA module and the board mounting the FPGA module of the present invention. 0027 is the FPGA module. 0029 to 0032 are the FPGAs mounted to the FPGA module 0027. 0036 to 0039 are the connectors mounted to the FPGA module 0027.

0010-1 is the board mounting, to accelerate the logic simulation, the connectors 0036 to 0039 for connection with the FPGA module 0027 to realize the verification object logic with the hardware, the general purpose interface to transmit and receive the signal to and from the personal computer and work station, and the device realizing the bridge circuit 0011 to exchange the data between the general purpose interface and the FPGA module 0027.

0011 is the device realizing the bridge circuit to exchange the data between the general purpose interface to transmit and receive the signal to and from the personal computer/work station and the FPGA module. 0059 to 0062 are the connectors to mount the FPGA module 0027 to the board 0010-1. 0063 is the device to configure the FPGA module 0027. 0001 is the logic emulation mother board. 0059-1 to 0062-1 are the connectors to mount the FPGA module 0027 to the board 0001-1. 0063-1 is the device to configure the FPGA module 0027. 0004, 0005 are the actual components to verify the interface with the logic mounted to the board 0001-1 such as memory and existing LSI or the like. 0003 is the connector to connect the logic emulation mother board and a signal input/output device such as external device.

The method to use in common the FPGA module 0027 with two verification methods of the acceleration of the logic simulation (step S0103 of FIG. 1) and logic emulation (step S0106 of FIG. 1) in FIG. 10 will be described. To the logic emulation mother board 0001-1 where the board 0010-1 mounting the general purpose interface to transmit and receive the signal to and from the personal computer/work station and the device which realizes the bridge circuit to exchange the data between the general purpose interface and the FPGA module, peripheral actual components and the interface connector for the input/output device are mounted for acceleration of the logic simulation, the common connector which can be connected to the connector mounted to the FPGA module 0027 is also mounted. Accordingly, the FPGA module 0027 can be mounted physically to both 0010-1 and 0001-1.

Moreover, the FPGAs on the FPGA module manufactured depending on the procedures described in the flow of FIG. 11 and configuration data of the switching device are programmed to the FPGA module 0027. Here, the same data can be configured to the FPGA module to operate the boards 0010-1 and 0001-1 by setting the same method to configure the configuration data to FPGA and switching device to the boards 0010-1 and 0001-1, and mounting the configuration circuit to the boards 0010-1 and 0001-1 in the identical structure and connection or connecting the configuration circuit via the connectors mounted to the board or the FPGA module. 0063, 0063-1 indicate the circuits for configuration. Usually, this circuit is composed of a memory or of a memory and a control circuit.

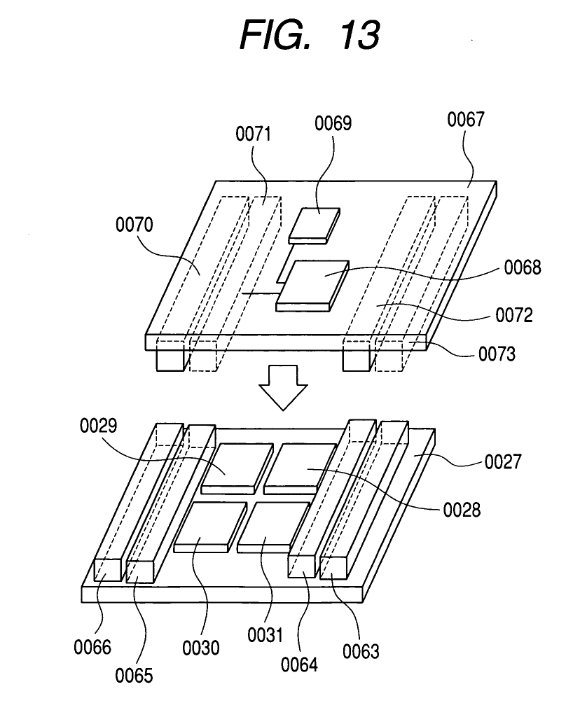

FIG. 13 is the external views for describing the connection examples of the FPGA module and the FPGA module configuration board of the present invention. 0027 is the FPGA module. 0029 to 0032 are the FPGAs mounted to the FPGA module. 0063 to 0066 are connectors mounted to the FPGA module. These connectors are used for connection with the option module having the stacking and configuration functions of the FPGA module. 0067 is an option module to realize the configuration function of the FPGA module 0027. 0068 is a device which realizes the circuit to control the configuration of the FPGA module 0027. 0069 is a memory to store the configuration data of the FPGA module 0027. 0070 to 0073 are the connectors to connect the option module 0067 to the FPGA module 0027.

For example, when the connector is mounted to the upper part of the FPGA module 0027 as illustrated in FIG. 13, the configuration board 0067 having the function to configure the FPGA module 0027 is mounted via this connector, and the configuration data is down-loaded to the FPGA module 0027 through the connector for the programming, if the configuration circuits 0063, 0063-1 are not mounted to the boards 0010-1, 0001-1, the same data can be configured to the FPGA module 0027 to operate the boards 0010-1 and 0001-1 only by transferring the FPGA module 0027 and the configuration board 0067 as a set to the board 0001-1 from the board 0010-1.

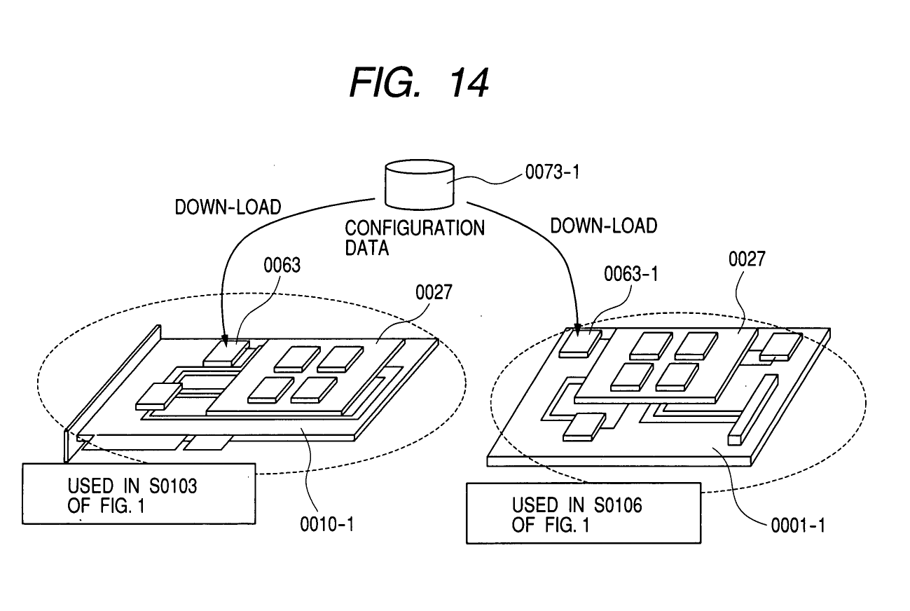

FIG. 14 is a diagram for describing an example of common use of the data in the logic simulation accelerator and the logic emulator of the present invention. 0001-1 is the logic emulation mother board, while the 0010-1 is the board mounting the connector for connection with the FPGA module 0027 to express the verification object logic with the hardware, the general purpose interface to transmit and receive the signal with the personal computer and work station and the device realizing the bridge circuit to exchange the data between the general purpose interface and FPGA module.

0063 and 0063-1 are the devices to configure the FPGA module 0027. 0067 is the option module to realize the configuration function of the FPGA module 0027, while 0068 is the device to realize the circuit to control configuration of the FPGA module 0027 and 0069 is the memory to store the configuration data of the FPGA module 0027.

0073-1 is the configuration data which is the logic information with the actual mounting information to be down-loaded to the FPGA module 0027. This information is inputted to the FPGA module 0027 in direct or via the device 0063 and memory 0069 in the 0063-1 or via the devices 0063, 0063-1 and memory 0069 to execute configuration of the FPGA module 0027.

Like FIG. 14, it is also possible to use in common only the data to program the logic (configuration data) to the FPGA module 0027 by individually mounting the identical FPGA modules to the boards 0010-1 and 0001-1. Namely, when the identical method where the configuration data is configured to the FPGA and switching device by inputting the same configuration data 0073-1 to the circuits 0063, 0063-1 for configuration on the boards 0010-1, 0001-1 is applied to both boards 0010-1 and 0001-1 and the circuits 0063, 0063-1 are mounted to the boards 0010-1 and 0010-1 in the identical structure and connection, the identical configuration data 0073-1 can be programmed to the respective FPGA modules 0027.

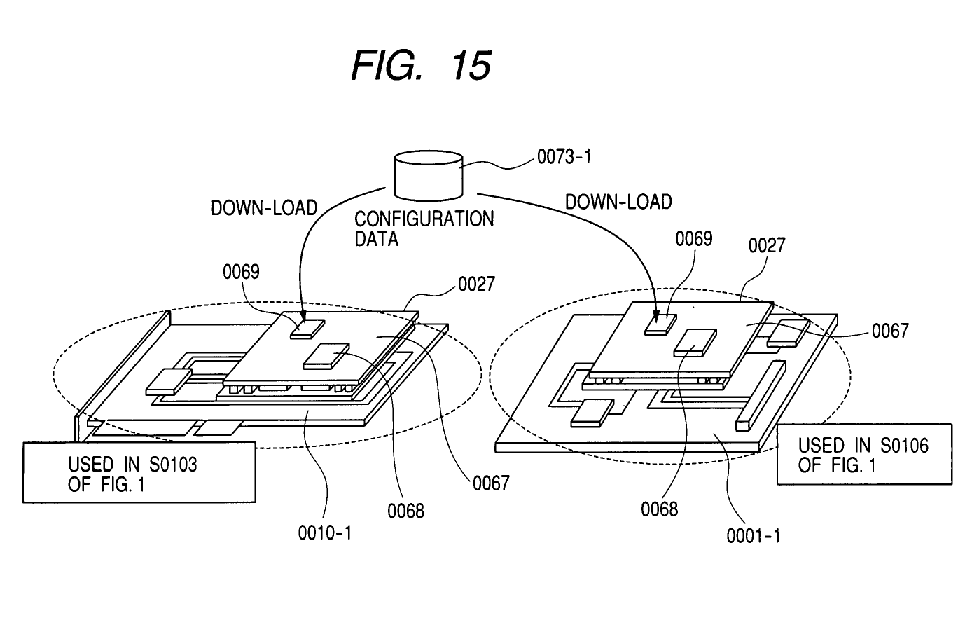

When the configuration board 0067 which can be mounted to the upper part of the FPGA module 0027 is used as illustrated in FIG. 15, it is also possible to change only the configuration board 0067 and it is also possible to use in common only the configuration data 0073-1 of the FPGA module 0027 inputted to the configuration board 0067 and to individually prepare the configuration board 0067 and the FPGA module 0027 to the boards 0010-1 and 0001-1.

In order to use in common the FPGA module 0027 with the boards 0010-1, 0001-1, the logic programmed to the FPGA module 0027 and the interface with external side (peripheral components) must be identical for the boards 0010-1 and 0001-1. The external interface of the FPGA module 0027 is determined in the assignment of the pins to the connector on the FPGA module with the process (step S0904) of FIG. 11. As described above, the assignment of connector pins is generally determined based on the wiring of the substrate of the board 0001-1. Therefore, the desired signal must be inputted or outputted for all pins of at least FPGA module in the side of the board 0010-1, but the signal can be inputted and outputted for all pins from the general purpose processor via the bridge circuit by connecting in direct all pins of the FPGA module and the bridge circuit 0011 on the board 0010-1 and transmitting and receiving a set of the pin information of the FPGA module and the data information in the side of the general purpose processor as described later.

The method to transmit and receive the signal with the logic simulator on the general purpose processor and the FPGA module in line with the external interface of the logic programmed in the FPGA module will be described. The external interface of logic programmed in the FPGA module is assigned to any pin of the connector on the FPGA module. For example, during the data transfer between the general purpose processor and the bridge circuit, the numbers are assigned in advance to the pins of connector on the FPGA module, a value of each signal is set in the logic simulator in the order of the number and the signal is transmitted to the bridge circuit, and such value is set in the bridge circuit and the signal is then received in the logic simulator side. By doing so, even if the external interface of the logic programmed in the FPGA module is assigned in any way to the pins, change of signal assigned to each connector pin can be transmitted and received with the logic simulator and FPGA module, by inputting the correspondence between the number previously assigned to the connector pin in the logic simulator side and the external interface signal.

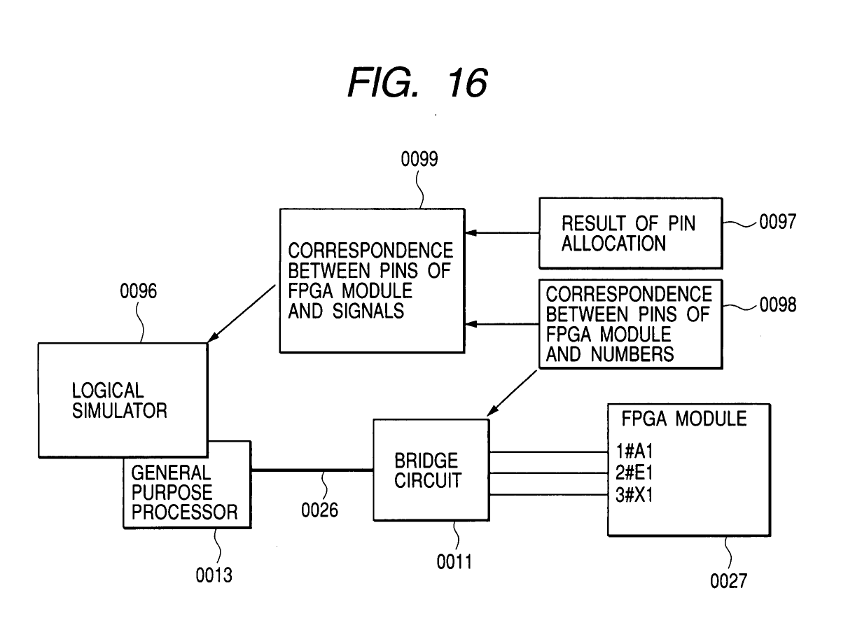

FIG. 16 is a structural diagram for describing the method to determine the correspondence of signals between the FPGA module and logic simulator of the present invention. 0027 is the FPGA module. 0011 is the bridge circuit for data transmission and reception between the FPGA module 0027 and the general purpose processor 0013. 0096 is the logic simulator operating on the general purpose processor 0013. 0097 is a result of connector pin assignment of the external interface of logic in the FPGA module 0027. 0098 is a correspondence table in which the number is assigned to the connector pins of the FPGA module 0027. 0099 is a correspondence table between the external interface of logic in the FPGA module 0027 and the number given to the connector pins determined with the correspondence table 0098. This correspondence table is generated with the pin allocation result 0097 and the correspondence table 0098.

For example, it is assumed that the pins 1#A1, 2#E1, 3#X1 exist in the FPGA module 0027, the port A and the port B are respectively assigned to the pins 1#A1 and 2#E1 with the process of the step S0904 of FIG. 11, and the port is not assigned to the pin 3#X1. Moreover, it is also assumed that a table where the number is assigned to the connector of the FPGA module 0027 is prepared.

As the process result in the step S0904 of FIG. 11, it is obtained that the port A is assigned to the pin 1#A1, the port B is assigned to the pin 1#E1, and any port is not assigned to the pin 3#X1, and the correspondence table among this process result, the pins 1#A1, 2#E1, 3#X1 corresponding to the numbers 1, 2, 3 given to the connector pins of the FPGA module and the external interface of the FPGA module (pin number 1 is port A, pin number 2 is port B) are generated. Thereafter, the logic simulator transmits and receives the signal to and from the bridge circuit 0011 in the order corresponding to the correspondence table by inputting the correspondence table to the logic simulator 0096.

In this case, a dummy data is transmitted and received to and from the pin 3#X1. Otherwise, it is also possible to transmit and receive a set of the pin number 3#X1 and signal value between the logic simulator and bridge circuit. The bridge circuit can output the data received with any one of methods described above to the predetermined pins of the FPGA module by storing the correspondence between the pin and the number of the FPGA module 0027. Moreover, the signals obtained from the FPGA module can be sequentially ordered again depending on the previously stored correspondence between the pins and the numbers of the FPGA module or a set of the signals and numbers can also be transmitted to the general purpose processor. Employment of this method the FPGA module can freely assign the connector pins for the port of logic matching with the substrate of the board 0001-1 without relation to physical connection between the bridge circuit of the board 0010-1 and the FPGA module 0027. As a result, common use of the configuration data is possible between the boards 0010-1 and 0001-1.

However, when the two-way signal exists at the port of logic programmed to the board 0010-1 as described above, since it is sometimes impossible to recognize the direction of such two-way signal in the logic simulator side, it is required that the direction control signal of the two-way signal is obtained from the FPGA module 0027 and it is then transmitted to the logic simulator side. As a measure to solve this problem, it is considered to introduce the method that the direction control signal of two-way signal is added to the logic as the port or the pins of connector of the FPGA module and it is then transmitted to the logic simulator side. In this case, the cutting end of the FPGAS module is different from the verification object logic and the number of pins also increases. As a method of preventing such condition, the present invention has developed the following method to transfer the direction control signal of two-way signal.

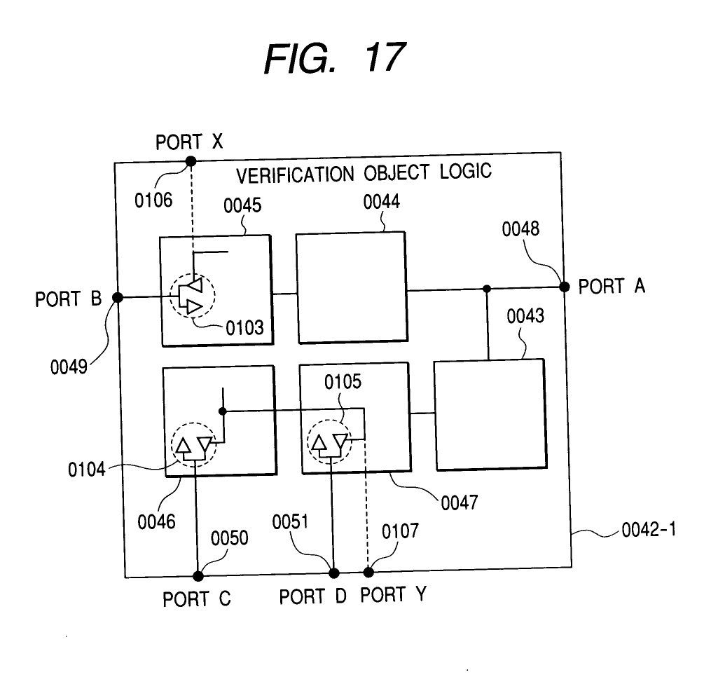

FIG. 17 is a diagram for describing an example to add the direction control signal of the two-way signal to the verification object logic. 0042-1 indicates the highest hierarchy of the logic to be programmed to a plurality of FPGAs or to the FPGA module. 0043 to 0047 are the function blocks to realize each function of the logic. In this embodiment, the function block is allocated under the highest hierarchy but it is also possible to allocate the hierarchy where a plurality of functions are provided between the highest hierarchy and the function block. The function blocks are coupled with a net to transmit and receive the signals. 0048 to 0051 indicate ports of the highest hierarchy which are the interfaces between the logic and external side. 0103 to 0105 are I/O two-way cells connected to the ports 0049, 0050, 0051. 0106, 0107 are ports added to transmit the direction control signal of the I/O two-way cells 0103 to 0105 to the general purpose processor via the bridge circuit.

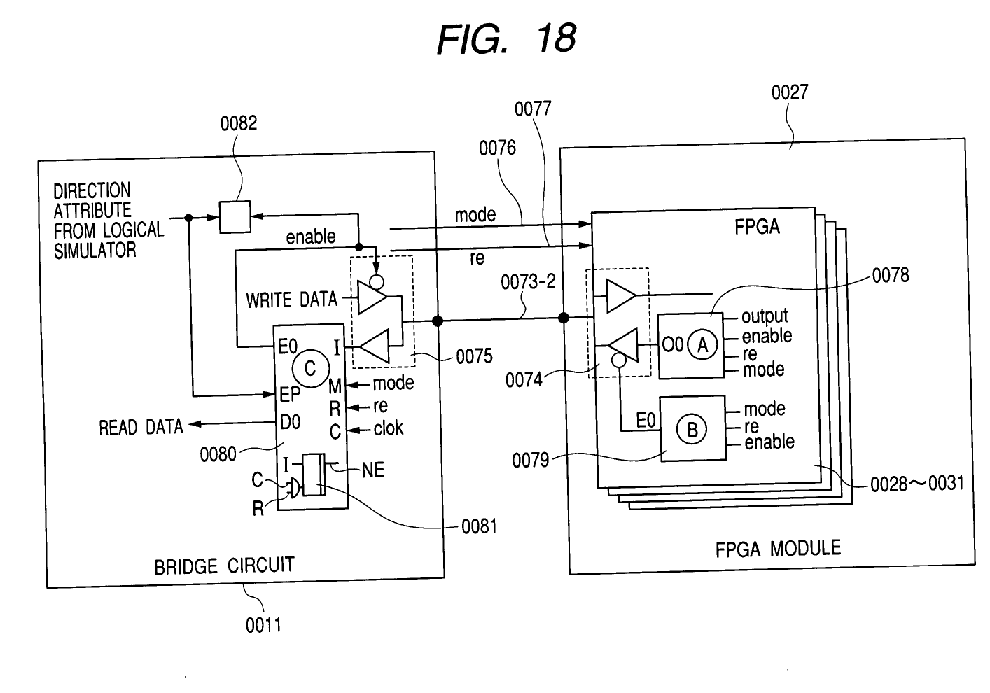

FIG. 18 is a block diagram showing an embodiment between the bridge circuit and FPGA module of the present invention. The circuit of FIG. 18 transmits, on the time division basis, the direction control signal of two-way signal to the bridge circuit from the FPGA module through the connection of two-way signal controlled therewith. The circuits 0078(A), 0079(B) are previously inserted to the I/O description point of the two-way signal of the logic programmed to the FPGA module. These circuits 0078(A), 0079(B) have two functions.

One is the function regarding a signal (mode) 0076 and another is the function regarding a signal (re) 0077. The function regarding the signal (mode) 0076 is to switch the operations of two two-way ports such that the logic operation before insertion of the circuit is performed when the signal (mode) has logical value, for example, “0”, while the operation to transfer the direction control signal of the two-way signal and the two-way signal itself is performed on the time division basis when the signal has the logical value “1”. Switching of mode enables that the intrinsic logic operation is executed during logic emulation, while the direction control signal of two-way signal is transferred to the bridge circuit with correspondence to the two-way signal without increase of pins when the logic simulation is accelerated. The signal (mode) 0076 sets respective values from the bridge circuit and logic emulation mother board.

On the other hand, the function regarding the signal (re) enables that when the operation to transfer, on the time division basis, the direction control signal of two-way signal and the two-way signal itself is selected, the transmission timing of the two-way signal and direction control signal is transmitted to the FPGA module from the bridge circuit, and the two-way signal and direction control signal are respectively transmitted to the bridge circuit depending on change of the signal. In the circuit of FIG. 18, the signal (re) 0077 indicates the transmission timing of the two-way signal and direction control signal, while the direction control signal is transmitted when the logical value of signal (re) 0077 is “1” and the two-way signal itself is transmitted in other cases. The signal (re) 0077 sets respective values from the bridge circuit when the logic simulation is accelerated. In the logic emulation, it is enough when the signal (re) 0077 is fixed, on the mother board, to the logical value “0” or “1”. The truth value table indicating the circuit operations of the circuits 0078 and 0079 is illustrated in the next truth value tables 1 and 2.

Truth value table 1:

| M | R | E | OI | OI |
|---|---|---|---|---|
| 0 | — | — | 0/1 | OI |
| 1 | 1 | 1/0 | — | E |
| 1 | 0 | — | 0/1 | OI |

Truth value table 2:

| M | R | E | EO |
|---|---|---|---|
| 0 | — | 1/0 | E |
| 1 | 1 | — | 0 |
| 1 | 0 | 1/0 | E |

On the other hand, in the bridge circuit side, there is provided a circuit 0080(C) to separately obtain the two-way signal and direction control signal transmitted from the FPGA module. The circuit 0080 has a storage element 0081 to store the direction control signal transmitted from the FPGA module when the signal (re) has the logical value “1”. The circuit 0080 controls, when the signal (re) has the logical value “0”, the direction of the I/O of the bridge circuit based on the value of the direction control signal transmitted from the logic simulator side, in place of the direction control signal read from the FPGA module. The circuit 0080 also has the function to control the direction of the I/O of the bridge circuit based on the value of the direction control signal read from the FPGA module when the signal (mode) has the logical value “1”. Moreover, it also has the function to set, when the signal (re) has the logical value “1”, the direction of I/O of the bridge circuit to the input direction viewed from the bridge circuit in order to read the direction control signal and then to store the readout value to the storage element 0081. The truth value table indicating the operations of the circuit 0080 and storage element 0081 is illustrated in the truth value tables 3 and 4.

Truth value table 3:

| M | R | EP | NE | EO |
|---|---|---|---|---|
| 0 | — | 0/1 | — | EP |
| 1 | 1 | — | — | 1 |
| 1 | 0 | — | 1/0 | NE |

Truth value table 4:

| C | R | I | NE |
|---|---|---|---|
| ↑ | 1 | 1/0 | I |
| ↑ | 0 | — | Hold |

When the logic simulator side recognizes the direction of each two-way signal, the circuit 0082 obtains the direction of two-way signal from the logic simulator side in the same manner as the signal value and the compares such value with the value of the direction control signal of two-way signal transmitted from the FPGA module when the signal (mode) has the logical value “1”. When the result of comparison is disagreement, it means collision of signals is generated between the circuit on the logic simulator and the logic programmed to the FPGA module. Collision of two-way signals may be detected by reading this comparison result, for example, from the bridge circuit via the general purpose interface. This comparison may also be executed on the general purpose processor.

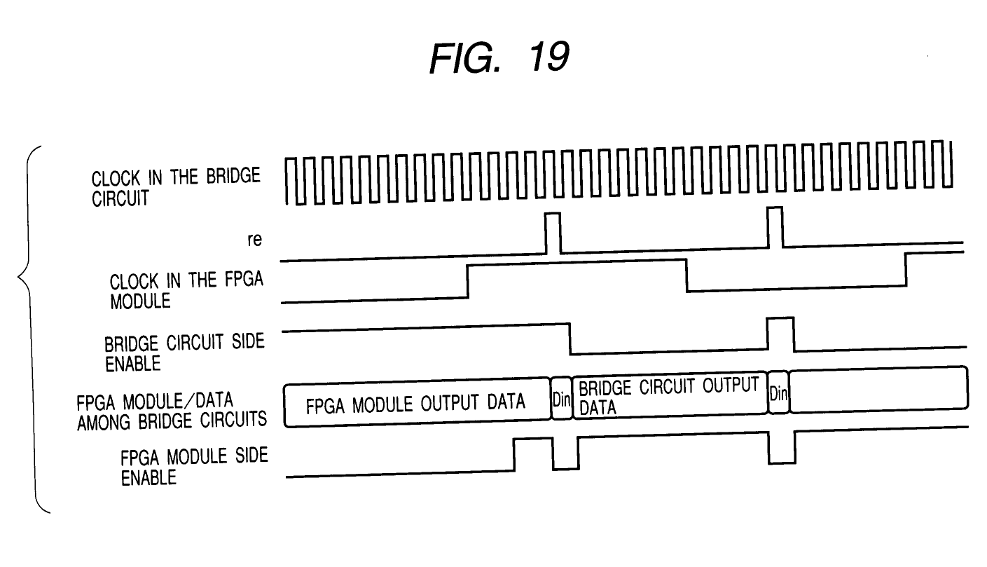

FIG. 19 is a timing chart for describing operations of the embodiment circuit of FIG. 18. Signal changes of the wire 0073-2 between the bridge circuit and FPGA module in this figure, when the direction control signal of two-way signal is transmitted on the time division basis to the bridge circuit from the FPGA module using the connection of the two-way signal controlled therewith, will be described. First, the clock signal in the bridge circuit and FPGA module when the logic simulation is accelerated will be described. The clock of the bridge circuit operates in the clock frequency matched with the general purpose interface in order to exchange of data with the general purpose infterface.

Meanwhile, since the input signal for the logic programmed via the general purpose interface and bridge circuit is transmitted from the general purpose processor, the clock of the FPGA module must be operated in accordance with the transmission timing. Therefore, the clock or clock enable is transmitted to the FPGA module from the bridge circuit side. The logic programmed to the FPGA module updates a value of internal register depending on change of one or a plurality of clocks and also changes the output. Therefore, signal transmission and reception between the bridge circuit and FPGA module is performed, for example, in the following order.

(1) Signal input to the FPGA module

(2) Change of clock of the FPGA module

(3) Read of output signal from the FPGA module

The timing to read the direction control signal of two-way signal from the FPGA module is set between the timings of (2) and (3). In FIG. 18, the enable, namely the control signal in the FPGA module side is in the logical value “0” (low level) in the initial condition, while the enable in the bridge circuit side is in the logical value “1” (high level). When the FPGA module and I/O cell of the bridge circuit are in the low active condition, this condition indicates that the FPGA module is in the output condition. Therefore, a signal value of the wire 0073-2 in this timing is equal to the logical value of two-way signal outputted from the FPGA module. This condition is identical to the condition of (1).

Next, in the condition of (2), the clock is generated for the FPGA module. Accordingly, the enable in the FPGA module side changes to the value of next cycle depending on the change of clock. In the case of FIG. 19, the logical value “0” changes to “1”. However, since change of enable in the FPGA module is not yet read in the bridge circuit side, the logical value remains as “1”. After the clock is generated for the FPGA module, the bridge circuit side changes the signal (re) to the logical value “1” in order to read the enable condition of the FPGA module side in the cycle depending on the change of clock after keeping the sufficient time for the FPGA module to setup the operation with the changed clock.

Accordingly, the signal direction is set temporarily to provide the FPGA module as the output and the bridge circuit side as the input and the bridge circuit extracts the logical value of enable in the FPGA module outputted from the FPGA module to the wire 0073-2. Namely, when the signal (re) has the logical value “1”, the wire 0073-2 has the logical value “1” of enable in the FPGA module. Therefore, the bridge circuit extracts this value. Upon completion of extraction of this value, the bridge circuit returns the signal (re) to the logical value “0” and the FPGA module has the logical value “1” of enable. Accordingly, the bridge circuit also detects that the FPGA module becomes the input and changes its direction control to the output side, namely changes the logical value of the signal (re) to “0” from “1”. Thereby, the wire 0073-2 is driven with the output value from the bridge circuit. With repetition of these processes, a value of enable in the FPGA module which is updated with change of clock can be reflected on the I/O control of the bridge circuit.

This method is only required, not depending on the number of two-way signals, to add two signals (mode, re) to the logic. Accordingly, it provides the merit, in comparison with the existing method to add the direction control signal to the port, that a degree of change for the interface of the verification object logic is rather small and the same configuration data can be used for both acceleration of logic simulation and logic emulation by setting the signal (mode, re) with the logic emulation.

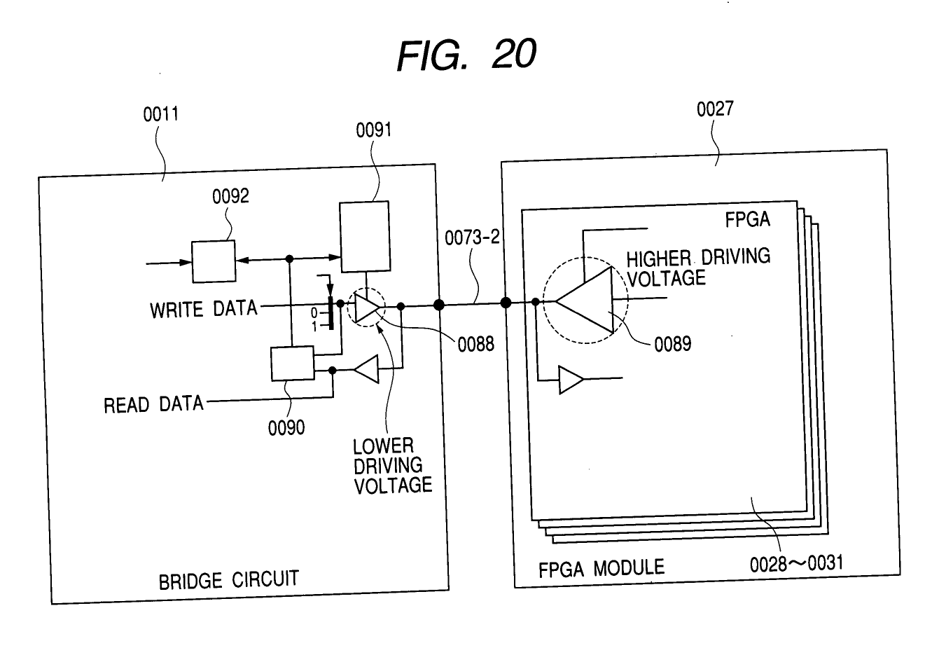

FIG. 20 is a block diagram of another embodiment between the bridge circuit and FPGA module of the present invention. The circuit of FIG. 20 does not include change for the interface of the verification object logic and does not add any modification to the verification object logic. This embodiment can be characterized in that a drive power of the output buffer of the I/O cell 0089 having the interface with the FPGA module in the bridge circuit side is set sufficiently lower than that of the FPGA module 0090, signals are temporarily collides with each other in the wire 1304 between the bridge circuit and FPGA module, and direction of the two-way signal in the FPGA module side is determined by reading the change of signals in such collision of signals.

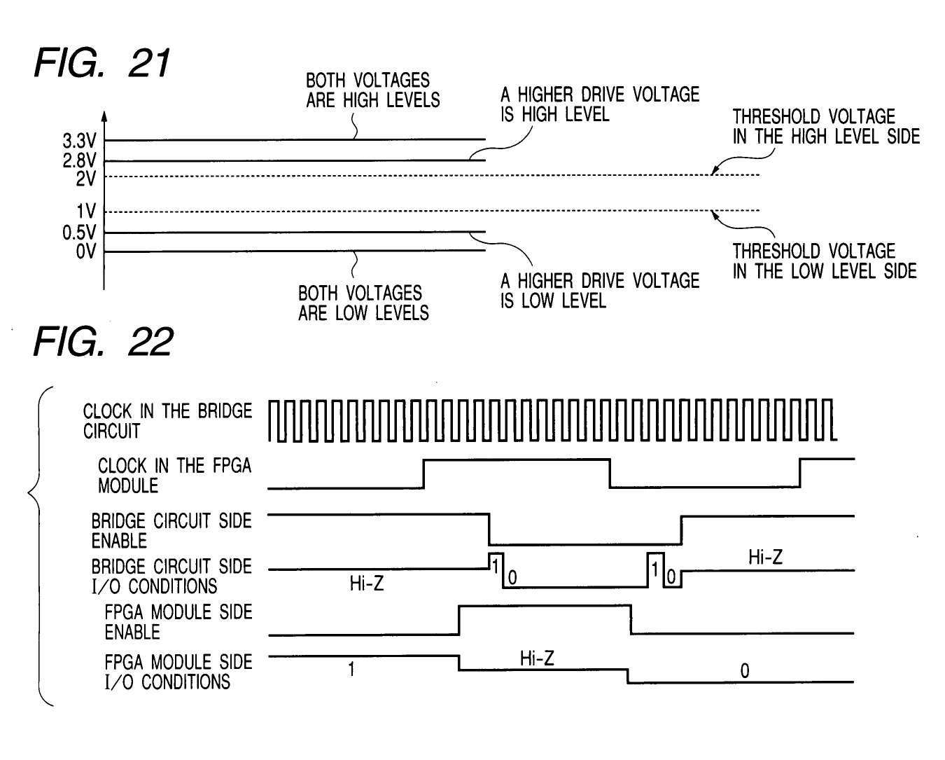

FIG. 21 is a level setting diagram for describing the method of determining the signal direction in FIG. 20. When the signals collide between the output buffer of higher drive power and the output buffer of lower drive power, signal potential depends on the output value when both output values are identical. When these output values are different, signal potential becomes equal to the value near the value driven with the output buffer of higher drive power. In the case of the circuit of FIG. 20, since the output buffer of sufficiently lower drive power in comparison with the FPGA module is used in the bridge circuit side, the signal takes the potential near to the value driven with the output buffer of higher drive power than the threshold value of both H/L levels (high/low levels) of the I/O cell of the bridge circuit. As a result, the logical value “1” is extracted when the potential is higher than the threshold value of the H side in the I/O cell of the bridge circuit, while the logical value “0” is extracted when the potential is lower than the threshold value of the L side.

Accordingly, when the bridge circuit outputs two values of H (logical value “1”) and L (logical value “0”), any one is different from the output value when the FPGA module side outputs a value and the output value is read as it is when the FPGA module does not output a value. Therefore, the signal direction in the FPGA module side can be determined in the bridge circuit side. The circuit for this determination is illustrated as the circuit 0090 of FIG. 20. Moreover, the result determined by the circuit 0091 is reflected on the direction control of the I/O cell in the bridge circuit side. When the logic simulator side recognizes, like the embodiment circuit of FIG. 18, the direction of each two-way signal, collision of two-way signals can be detected by obtaining the direction of two-way signal from the logic simulator with the method same as that of the signal value in the circuit 0092 and then comparing the direction obtained with the determination result in the circuit 0090.

FIG. 22 is a timing chart for describing the operations of the embodiment circuit of FIG. 20. Condition of the I/O cell in the bridge circuit side and condition of the I/O cell in the FPGA module side are described. Clocks of the bridge circuit and FPGA module are as described in regard to FIG. 19. In the initial condition of this timing chart, the FPGA module side is the output, while the bridge circuit side is the input as in the case of FIG. 19.

Change of clock of the FPGA module changes the logical value of the FPGA module side to “1” from “0”. In the bridge circuit side, after generation of clock, sufficient time is given to set up the operation of the FPGA module with the changed clock and the logical value “1” is outputted first and the logical value “0” is outputted next to the wire 0073-2 in order to read the enable condition in the FPGA module side of the cycle depending on the change of clock. In this case, the signal may be outputted in the sequence of the logical values “0” and “1”. The output timing of this signal is identical to the timing of generation of the signal (re) of FIG. 19.

In the case of example illustrated in the figure, since the I/O of the FPGA is the input (I), it has the condition Hi-Z (output high impedance). Accordingly, the signal value on the wire 0073-2 can be read as the logical value “1” in the bridge circuit side when the logical value “1” is outputted and can also be read as the logical value “0” when the logical value “0” is outputted. In this case, since the read data changes corresponding to the output value of the output buffer 0088 of the bridge circuit, the bridge circuit side is determined as the output.

With the next change of clock, the enable in the FPGA module side changes to the logical value “0” and thereby the I/O of the FPGA module changes to the output. Since the bridge circuit reads the enable condition of the FPGA module side in the clock change cycle, it outputs first the logical value “1” from the output buffer 0088 and outputs next the logical value “0” to the wire 0073-2. Since the I/O of the FPGA is output, the condition is maintained at the logical value “0” or “1” outputted from the output buffer 0089.

In the example of FIG. 22, since an output of the output buffer 0089 is logical value “0”, the read data can be read as “0”in the bridge circuit side even when the output buffer 0088 outputs the logical value “1” or can be read as “0” even when the output buffer 0088 outputs the logical value “0”. In this case, the bridge circuit side is determined as the input. With repetition of these processes, the value of enable in the FPGA module which is updated with change of clock can be reflected on the I/O control of the bridge circuit as in the case of the circuit of FIG. 18.

With employment of the method described above, the interface is never changed depending on the logic even when the two-way signal exists in the interface of verification object logic and moreover the interface of the FPGA module can be matched with the logic emulation and acceleration of logic simulation including the physical position by using the FPGA module and matching assignment of logic signal for the pins of connector of the FPGA module to the logic emulation mother board. Accordingly, it is possible to use the same FPGA module and configuration data in the two verification process for the logic emulation and logic simulation. For the FPGA module, the same type of module is individually prepared and thereby the same configuration data can also be used.

In the embodiment described above, since the same FPGA module and configuration data can be used in the two verification processes for the logic emulation and logic simulation, it is no longer required to individually prepare the data in the two verification processes. Namely, when the jobs up to the step S0905 from the step S0901 are implemented in the step S0103, it is no longer required to execute this job in the step S0106, the acceleration of logic simulation can be shifted smoothly to the logic emulation.

Moreover, the phenomenon that the logic simulation is accelerated normally but logic emulation does not operation normally due to the mistake in the jobs up to the step S0905 from the step S0901 or the reverse phenomenon thereof are never generated and the logic emulation can be executed with the data recognized to a certain degree in the logic simulation process, the logic emulation can be driven easily. Accordingly, the verification processes in two processes of the step S0103 and step S0106 can be reduced remarkably.

Moreover, defect of interface with peripheral components in the logic emulation can be analyzed and recognized by returning to the logic simulation. In addition, collision of the two-way signals which can be detected only with the logic emulation can be detected previously with the logic simulation.

The effect obtained above is the common effect obtained by the case where the FPGA module is used in common in the steps S0103 and S0106 of FIG. 1 and the case where only the configuration data is used in common but the FPGA module is used individually. However, when only the configuration data is used in common, the implementation period of the steps S0103 and S0106 can be prepared in parallel to a certain degree and moreover the logic verification period can be shortened. In addition, even if the job is executed in the isolated place, acceleration of logic simulation and logic emulation can be implemented using the same data when there is provided a means for sending the data (for example, Ethernet).

As described above, acceleration of logic simulation and logic emulation can be realized without change of logic data in the same FPGA module. Namely, it is not required to change the cutting end of the logics mounted on the FPGA module. Since contents of logics for coupling H/W and S/W, timing and interface are never changed depending on the logic, the timing of the logic side can be designed easily. In other words, since the logics for coupling H/W and S/W does not depend on the logics mounted to the FPGA module, it is not required to reform the FPGA module depending on the logics. When the enable information for two-way port is provided in the S/W side, this information can be compared with the information read from the FPGA module and thereby collision of buses can also be detected.

Since execution time of the logic simulation can be reduced, the period required for verification phase in the LSI development can also be shortened. Since the FPGA module mounting the logic of which quality is ensured to a certain degree by the logic simulation can be applied in direct to the logic emulation, execution time of the logic simulation can be shortened, many verification cases can be executed and logic failure which cannot be detected easily with the logic simulation can be detected with the logic emulation, design quality in the LSI development can be improved.

The present invention has been described practically on the basis of the embodiments thereof, but the present invention is never limited thereto and naturally allows various changes and modifications within the scope not departing from the claims thereof. For example, the FPGA module, bridge circuit and respective circuits related to these may introduce various embodiments. The present invention may be widely used as the logic verification system.

Effects of the present invention may be briefly described as follows. When all pins of the FPGA module are connected in direct and the logic simulation is accelerated between the FPGA module and bridge circuit used in the verification processes of the logic simulation accelerator and logic emulator, the cutting end of the verification object logic is assigned to the external interface connector of the FPGA module and correspondence between each pin of the external interface connector of the FPGA module and the logic numbers is performed on the general purpose processor. Thereby, the development time can be improved and design quality can also be improved.

What is claimed is:

1. A logic verification system utilizing the same FPGA module and the same configuration data in a couple of verification processes of logic emulation and logic simulation.

2. A logic verification system comprising:
a logic simulation accelerator including:
a device operating on a general purpose processor;
a device including a programmable logic device using FPGAs; and
a bridge circuit for transmitting and receiving data between said device operating on said general purpose processor and said device including the programmable logic device using said FPGAs,
wherein when the FPGA module used in the verification process in said logic emulator and the bridge circuit are wired in direct for all pins of said FPGA module and the logic simulation is accelerated, the cutting end of the verification logic is assigned to an external interface connector of the FPGA module, and the correspondence between each pin of the external interface connector of said FPGA module and logic signal is performed on said logic simulator on said general purpose processor.

3. The logic verification system according to claim 2, wherein the logic mounted on said FPGA module is provided with a means for transmitting a direction control signal of two-way signal controlled therewith to the bridge circuit using an interface.

4. The logic verification system according to claim 2, wherein a means for automatically detecting a signal direction of two-way signal between said FPGA module and the device mounting the bridge circuit is provided, and the program data of the same FPGA group mounting the verification object logic is used in a couple of verification processes of the acceleration of logic simulation and logic emulation.

5. The logic verification system according to claim 4, wherein said means for automatically detecting the signal direction of two-way signal between said devices is capable of setting a drivability level of output circuits of both devices and giving the priority in determination of signal direction to the device having higher drivability.

6. The logic verification system according to claim 4, comprising: a means for automatically detecting signal direction of two-way signal between said FPGA module and the device mounting the bridge circuit; and a means for inputting signal direction of two-way signal to the logic simulator on the general purpose processor,
wherein the signal direction of logic simulator and disagreement of signal direction in the FPGA module is detected by comparing said two signal directions.

7. The logic verification system according to claim 6, wherein said means for automatically detecting signal direction of two-way signal between said devices is capable of setting a drivability level of output circuits of both devices and giving the priority in determination of signal direction ot the device having higher drivability.
